(19) United States
(12) Patent Application Publication
(10) Pub. No.: US 2025/0328773 A1
(43) Pub. Date: Oct. 23, 2025

(54) METHOD AND APPARATUS FOR PREFERENCE-TRAINING LANGUAGE MODEL

(71) Applicant: SAMSUNG SDS CO., LTD., Seoul (KR)

(72) Inventors: Ju Youn SON, Seoul (KR); Woo Seok Jang, Seoul (KR); Joon Ho Lee, Seoul (KR); Ju Ree Seok, Seoul (KR)

(73) Assignee: SAMSUNG SDS CO., LTD., Seoul (KR)

(21) Appl. No.: 19/072,402

(22) Filed: Mar. 6, 2025

(30) Foreign Application Priority Data
Apr. 17, 2024 (KR) 10-2024-0051107
Sep. 4, 2024 (KR) 10-2024-0119704

(51) Int. Cl. G06N 3/092; G06N 3/0475

(52) U.S. Cl. CPC G06N 3/092; G06N 3/0475

(57) ABSTRACT

A method and apparatus for preference-training a language model are provided. The method according to some embodiments may include obtaining a dataset including a plurality of pieces of response data, wherein each of the plurality of pieces of response data includes multiple responses generated by the language model for a query and user preference information corresponding to each of the multiple responses, filtering out some of the plurality of pieces of response data included in the dataset using reward values for each of the plurality of pieces of response data, output from a proxy model that receives the dataset as input and training the language model using other pieces of response data that have not been filtered out.

### CROSS-REFERENCE TO RELATED APPLICATIONS

This application claims priority from Korean Patent Application No. 10-2024-0051107 filed on Apr. 17, 2024, and Korean Patent Application No. 10-2024-0119704 filed on Sep. 4, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and apparatus for preference-training a language model, and more specifically, to a method for filtering training data and optimizing a language model using the filtered training data, and an apparatus for performing the method.

### 2. Description of the Related Art

Discussions are ongoing regarding methods for optimizing language models using human feedback on responses generated by language models to enhance the reliability of language models.

Various techniques for preference-training language models using preference datasets that include user preference information on responses generated by language models have emerged and are being widely adopted, such as Reinforcement Learning from Human Feedback (RLHF) and Direct Preference Optimization (DPO).

In a method for preference-training a language model, a preference dataset is a critical factor that significantly affects the performance of the language model. A preference dataset that includes noise can degrade the performance of the language model.

Therefore, a new approach is needed to address the issue of degraded performance caused by noise in the training data during preference-training of a language model.

### SUMMARY

An objective of the present disclosure is to provide a method for constructing a reliable dataset for preference-training a language model and a computing device for performing the method.

Another objective of the present disclosure is to provide a method for reducing the time/space resources required for preference training and improving the performance of a language model by using a noise-removed dataset to preference-train the language model, and a computing device for performing the method.

Yet another objective of the present disclosure is to provide a method for improving the instruction-following ability of a language model to generate responses aligned with user intent by halting the preference training of the language model using a dataset, if a predefined stopping condition is met, and retraining the language model using a noise-removed dataset obtained by filtering out noise from the existing dataset, and a computing device for performing the method.

The objectives of the present disclosure are not limited to those mentioned above, and other objectives not explicitly stated will be clearly understood by those skilled in the art based on the following description.

According to an aspect of the present disclosure, there is provided a method for preference-training a language model performed by a computing device. The method may include obtaining a dataset including a plurality of pieces of response data, wherein each of the plurality of pieces of response data includes multiple responses generated by the language model for a query and user preference information corresponding to each of the multiple responses, filtering out some of the plurality of pieces of response data included in the dataset using reward values for each of the plurality of pieces of response data, output from a proxy model that receives the dataset as input and training the language model using other pieces of response data that have not been filtered out.

In some embodiments, the proxy model may be trained through supervised learning using training data that includes the query, a response generated by the language model for the query, the user preference information for the response, and set reward value for the response.

In some embodiments, each of the plurality of pieces of response data may be configured as a response pair including a first response and a second response, user preference for the first response may be higher than user preference for the second response, the reward values for each of the plurality of pieces of response data may include a first reward value for the first response and a second reward value for the second response, and the filtering out some of the plurality of pieces of response data may include comparing the first and second reward values and removing, from the dataset, each piece of response data for which the first reward value is less than or equal to the second reward value.

In some embodiments, the filtering out some of the plurality of pieces of response data may include obtaining an uncertainty value for each of the plurality of pieces of response data included in the dataset, output from the proxy model, comparing the uncertainty value with a predefined threshold and removing, from the dataset, each piece of response data for which the uncertainty value is equal to or greater than the predefined threshold.

In some embodiments, the training the language model may be performed using one of a Reinforcement Learning from Human Feedback (RLHF) method or a Direct Preference Optimization (DPO) method.

According to another aspect of the present disclosure, there is provided a method for preference-training a language model, performed by a computing device. The method may include obtaining a dataset including a plurality of pieces of response data, wherein each of the plurality of pieces of response data includes multiple responses generated by the language model for a query and user preference information corresponding to each of the multiple responses, training the language model using the dataset to increase a likelihood of generating responses with higher user preference, and determining whether a stopping condition is met, when the stopping condition is met, halting the training the language model using the dataset, filtering out some of the plurality of pieces of response data included in the dataset and retraining the trained language model using only other pieces of response data that have not been filtered out.

In some embodiments, each of the plurality of pieces of response data may be configured as a response pair consisting of a first response and a second response, user preference for the first response may be higher than that for the second response, and the determining whether the stopping condition is met may include calculating a first reward value for the first response and a second reward value for the second response for each of the plurality of pieces of response data, calculating a reward accuracy of the language model, comparing the reward accuracy with a predefined threshold and determining that the stopping condition is met when the reward accuracy is equal to or greater than the predefined threshold, and the reward accuracy may be an average ratio of cases where the first reward value is greater than the second reward value to cases where the first reward value is less than the second reward value for each of the plurality of pieces of response data.

In some embodiments, each of the plurality of pieces of response data may be configured as a response pair consisting of a first response and a second response, user preference for the first response may be higher than that for the second response, and the filtering out some of the plurality of pieces of response data may include calculating a first reward value for the first response and a second reward value for the second response for each of the plurality of pieces of response data, comparing the first reward value and the second reward value and removing, from the dataset, each piece of response data for which the first reward value is less than or equal to the second reward value.

In some embodiments, the filtering out some of the plurality of pieces of response data may include calculating an uncertainty value for each of the plurality of pieces of response data, comparing the uncertainty value with a predefined threshold and removing, from the dataset, each piece of response data for which the uncertainty value is equal to or greater than the predefined threshold.

In some embodiments, the training the language model and the retraining the language model may be performed using a Direct Preference Optimization (DPO) method.

According to yet another aspect of the present disclosure, there is provided an apparatus for preference-training a language model. The apparatus may include at least one processor and at least one memory storing instructions that, when executed by the at least one processor, cause the at least one processor to perform operations of obtaining a dataset including a plurality of pieces of response data, wherein each of the plurality of pieces of response data includes multiple responses generated by the language model for a query and user preference information corresponding to each of the multiple responses, filtering out some of the plurality of pieces of response data included in the dataset using reward values for each of the plurality of pieces of response data, output from a proxy model that receives the dataset as input and training the language model using other pieces of response data that have not been filtered out.

In some embodiments, the proxy model may be trained through supervised learning using training data that includes the query, a response generated by the language model for the query, the user preference information for the response, and set reward value for the response.

In some embodiments, each of the plurality of pieces of response data may be configured as a response pair including a first response and a second response, user preference for the first response is higher than user preference for the second response, the reward values for each of the plurality of pieces of response data include a first reward value for the first response and a second reward value for the second response, and the operation of filtering out some of the plurality of pieces of response data may include comparing the first and second reward values and removing, from the dataset, each piece of response data for which the first reward value is less than or equal to the second reward value.

In some embodiments, the operation of filtering out some of the plurality of pieces of response data may include obtaining an uncertainty value for each of the plurality of pieces of response data included in the dataset, output from the proxy model, comparing the uncertainty value with a predefined threshold and removing, from the dataset, each piece of response data for which the uncertainty value is equal to or greater than the predefined threshold.

According to yet another aspect of the present disclosure, there is an apparatus for preference-training a language model. The apparatus may include at least one processor and at least one memory storing instructions that, when executed by the at least one processor, cause the at least one processor to perform operations of obtaining a dataset including a plurality of pieces of response data, wherein each of the plurality of pieces of response data includes multiple responses generated by the language model for a query and user preference information corresponding to each of the multiple responses, training the language model using the dataset to increase a likelihood of generating responses with higher user preference, and determining whether a stopping condition is met, when the stopping condition is met, halting the training the language model using the dataset, filtering out some of the plurality of pieces of response data included in the dataset and retraining the trained language model using only other pieces of response data that have not been filtered out.

In some embodiments, each of the plurality of pieces of response data may be configured as a response pair consisting of a first response and a second response, user preference for the first response may be higher than that for the second response, the operation of determining whether the stopping condition is met may include calculating a first reward value for the first response and a second reward value for the second response for each of the plurality of pieces of response data, calculating a reward accuracy of the language model; comparing the reward accuracy with a predefined threshold and determining that the stopping condition is met when the reward accuracy is equal to or greater than the predefined threshold, and the reward accuracy may be an average ratio of cases where the first reward value is greater than the second reward value to cases where the first reward value is less than the second reward value for each of the plurality of pieces of response data.

In some embodiments, each of the plurality of pieces of response data may be configured as a response pair consisting of a first response and a second response, user preference for the first response may be higher than that for the second response, and the operation of filtering out some of the plurality of pieces of response data may include calculating a first reward value for the first response and a second reward value for the second response for each of the plurality of pieces of response data, comparing the first reward value and the second reward value and removing, from the dataset, each piece of response data for which the first reward value is less than or equal to the second reward value.

In some embodiments, the operation of filtering out some of the plurality of pieces of response data may include calculating an uncertainty value for each of the plurality of pieces of response data, comparing the uncertainty value with a predefined threshold and removing, from the dataset, each piece of response data for which the uncertainty value is equal to or greater than the predefined threshold.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a configuration diagram illustrating an example of a language model training system according to an embodiment of the present disclosure;

FIG. 2 is a graph showing data distribution according to some embodiments of the present disclosure;

FIG. 3 is a flowchart illustrating a method for training a language model according to an embodiment of the present disclosure;

FIG. 4 is a flowchart illustrating a method for filtering a dataset according to some embodiments of the present disclosure;

FIG. 5 illustrates the overall operation of a language model training apparatus that operates according to some embodiments of the present disclosure, described with reference to FIGS. 3 and 4;

FIG. 6 is a flowchart illustrating a method for training a language model according to another embodiment of the present disclosure;

FIG. 7 is a flowchart illustrating an example of a method for determining whether a condition for halting training using response data that has not been filtered out is met according to some embodiments of the present disclosure;

FIG. 8 is a graph showing changes in reward accuracy and reward gap calculated during the training of a language model according to an embodiment of the present disclosure;

FIG. 9 illustrates the overall operation of a language model training apparatus that operates according to some embodiments of the present disclosure, described with reference to FIGS. 6 and 7;

FIG. 10 is a graph showing changes in reward accuracy and reward gap calculated the training of a language model using response data that has not been filtered out according to some embodiments of the present disclosure; and

FIG. 11 is a block diagram illustrating an exemplary computing device for performing some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of the present disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

In addition, in the present disclosure, “/” and “,” should be interpreted as “and/or.” For example, “A/B” and “A, B” may mean “A and/or B.”

The present disclosure proposes a method for preference-training a language model. In other words, the present disclosure proposes a method for training a language model using a dataset that reflects user preferences or human feedback on responses generated by the language model, so that the language model can generate responses aligned with user intent. Specifically, the present disclosure proposes a method for constructing a reliable dataset with noise removed for preference-training a language model and/or a method for training a language model using such a noise-removed dataset.

In the present disclosure, training a language model using a dataset 10 and/or a dataset that includes response data that has not been filtered out according to some embodiments of the present disclosure may refer to fine-tuning or optimizing a pre-trained language model to generate responses to specific queries, using response data that has not been filtered out.

Embodiments of the present disclosure will hereinafter be described with reference to the accompanying drawings.

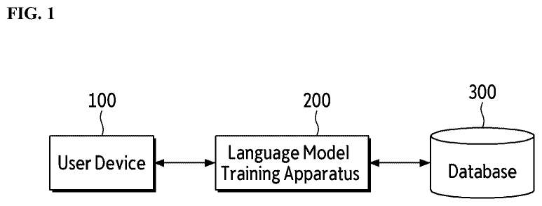

FIG. 1 is a configuration diagram illustrating a language model training system according to an embodiment of the present disclosure.

The language model training system of FIG. 1 may provide a framework for performing methods and/or operations according to some embodiments of the present disclosure. For example, the language model training system may refer to a system in which a platform is implemented to receive at least one query (or context) and generate/output at least one response for each query based on artificial intelligence (AI), according to some embodiments of the present disclosure.

In the present disclosure, a language model may refer to a large-scale language model (LLM) based on AI, which can learn various forms of text and perform operations such as analyzing and/or generating text. The language model may generate one or more responses to a given query.

In the following description, unless otherwise specified, the language model is assumed to represent an LLM. In other words, the language model subject to preference training according to some embodiments of the present disclosure is assumed to be an LLM that has been pre-trained to generate responses to specific queries. Additionally, the language model may also be referred to as a generative AI model, a question-answering model, or a conversational model.

Here, a query (or context) may include various forms of text, such as words, sentences, and/or their combinations. The responses generated by the language model in response to specific queries may also include various forms of text.

Referring to FIG. 1, the language model training system may include a user device 100, a language model training apparatus 200, and/or a database 300.

The user device 100 may include various devices used by the user to transmit and receive various data and/or information while communicating with other devices. The user device 100 may include a smartphone, tablet PC, and laptop, but is not limited thereto. For example, the user device 100 may include various computing devices equipped with wireless communication means and/or computing means. The user device 100 may be referred to as a user terminal, wireless device, mobile terminal, or portable device.

In the present disclosure, a user may refer to a person who generates and/or trains the language model, according to some embodiments of the present disclosure, or a person who obtains responses to specific queries using the language model, according to some embodiments of the present disclosure. For example, the user may input a specific query (or context) through the user device 100 and obtain a response to the input query generated by the language model.

The user device 100 may be used to utilize the language model training apparatus 200. For example, the user device 100 may receive a prompt input from the user that includes a specific query and output a response generated by a language model trained by the language model training apparatus 200 in response to the prompt input. Additionally, the user device 100 may receive user preference information regarding a plurality of responses generated by the language model for a query and store response data consisting of a pair of responses, one preferred by the user and one less preferred. Here, the response data may include the query, at least one response generated by the language model for the query, and user preference information for each generated response. Furthermore, the user device 100 may display a user interface implementing the functions of the language model training system.

The language model training apparatus 200 may perform operations for preference-training a language model according to some embodiments of the present disclosure using one or more models and/or datasets included in the database 300.

For example, before preference-training a language model, the language model training apparatus 200 may filter a training dataset and train the language model using a noise-removed dataset obtained through the filtering.

In another example, when a predetermined condition is met during preference training of a language model using a dataset, the language model training apparatus 200 may halt the training using the existing unfiltered dataset, filter the dataset, and restart training using a noise-removed dataset obtained from the filtering.

In the present disclosure, filtering a dataset may refer to filtering out (or removing) a portion of response data included in the dataset, and the filtered dataset may refer to a dataset comprising only of the remaining response data that has not been filtered out from the original (unfiltered) dataset.

The language model training system and/or the language model training apparatus 200 may be implemented on at least one computing device. For example, all functions of the language model training apparatus 200 may be implemented on a single computing device. In another example, some functions of the language model training apparatus 200 may be implemented on a first computing device, and the remaining functions may be implemented on a second computing device. Additionally, a specific function of the language model training apparatus 200 may be implemented on one or more computing devices.

The database 300 may include one or more models according to some embodiments of the present disclosure. For example, the database 300 may include a proxy model for outputting rewards and/or uncertainties for response data according to some embodiments of the present disclosure, a model for Reinforcement Learning from Human Feedback (RLHF) (e.g., a reward model), a model for Direct Preference Optimization (DPO)), and the like.

Additionally, the database 300 may include a language model subject to preference training according to some embodiments of the present disclosure and/or a training dataset for preference training according to some embodiments of the present disclosure.

The components illustrated in FIG. 1 may communicate via various types of wired or wireless networks. Apparatuses and/or systems according to the present disclosure may be applicable to, but are not limited to, a local area network (LAN), a wide area network (WAN), a mobile radio communication network, Wireless Broadband Internet (WiBro), and the like, and may also be applicable to any other arbitrary communication system.

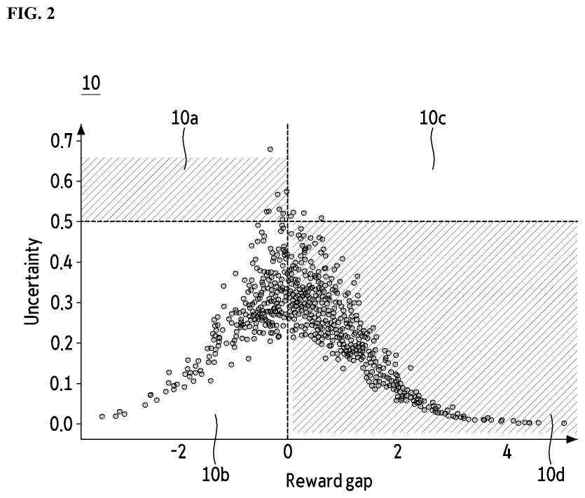

The dataset 10 for preference-training a language model will hereinafter be described with reference to FIG. 2.

Here, the dataset 10, which is a training dataset used for preference-training a language model, may include a plurality of pieces of response data for at least one query, and each of the plurality of pieces of response data may include multiple responses generated by the language model for a specific query and user preference information corresponding to each of the multiple responses.

The dataset 10 may include multiple sets of responses generated by the language model for each of multiple queries, along with user preference information for each of the multiple sets of responses. However, for ease of explanation, the dataset 10 is assumed to include a plurality of pieces of response data for a single specific query, but the present disclosure is not limited thereto. It is noted that the embodiments of the present disclosure described with reference to the accompanying drawings may also be applicable to a dataset 10 that includes multiple sets of pieces of response data for each of multiple queries.

For example, each of the plurality of pieces of response data included in the dataset may be a response pair consisting of a first response and a second response, which are different from each other, and the user preference for the first response may be higher than the user preference for the second response.

In the present disclosure, a response with a higher user preference, i.e., the first response, may be referred to as a “chosen response,” and a response with a lower user preference, i.e., the second response, may be referred to as a “rejected response.” Additionally, in the present disclosure, a training dataset (e.g., the dataset 10) used for preference training may also be referred to as a “preference dataset.”

Additionally, for ease of explanation, each piece of response data included in the dataset 10 is assumed to be configured as a response pair comprising two responses, but the present disclosure is not limited thereto. Alternatively, each piece of response data included in the dataset 10 may contain more than two responses that reflect user preferences.

Specifically, FIG. 2 is a graph illustrating the distribution of the response data included in the dataset 10.

The dataset 10 may include noise, which may significantly degrade the performance of a language model and thus needs to be removed.

For example, noise may refer to data where the chosen and rejected responses that constitute response data for a specific query are suspected to have been switched.

In another example, if a specific query (or context) input into the language model is unclear or incomplete, response data generated for the specific query may also be unclear. Therefore, noise may refer to data where the responses to the specific query are suspected to be uncertain.

In some embodiments of the present disclosure, reward values and/or an uncertainty value may be obtained/calculated for each piece of response data included in the dataset 10, and response data determined to be noise based on these values may be filtered out from the dataset 10, thereby filtering the dataset 10.

The distribution of the response data included in the dataset 10 may be represented based on the reward gap and/or the uncertainty value of each piece of response data, as shown in FIG. 2.

The reward gap may refer to the difference between the reward values for the first and second responses included in each response pair.

For example, response data 10a and response data 10b that both have a negative reward gap may be suspected of having their chosen responses and rejected responses switched and thus be determined as noise. According to some embodiments of the present disclosure, by removing both the response data 10a and the response data 10b from the dataset 10, a filtered dataset may be configured, which includes response data 10c and response data 10d that both have a positive reward gap that have not been filtered out.

In another example, the response data 10a and the response data 10c that both have an uncertainty value greater than a predefined threshold may be determined as noise. According to some embodiments of the present disclosure, by removing both the response data 10a and the response data 10c from the dataset 10, a filtered dataset may be configured, which includes the response data 10b and the response data 10d that both have an uncertainty value less than the predefined threshold that have not been filtered out.

In yet another example, the response data 10a and the response data 10b that both have a negative reward gap, and the response data 10a and the response data 10c that both have an uncertainty value greater than the predefined threshold may all be determined as noise. According to some embodiments of the present disclosure, by removing all such noise from the dataset 10, a filtered dataset may be configured, which includes the response data 10d that have a positive reward gap and an uncertainty value less than the predefined threshold and have not been filtered out.

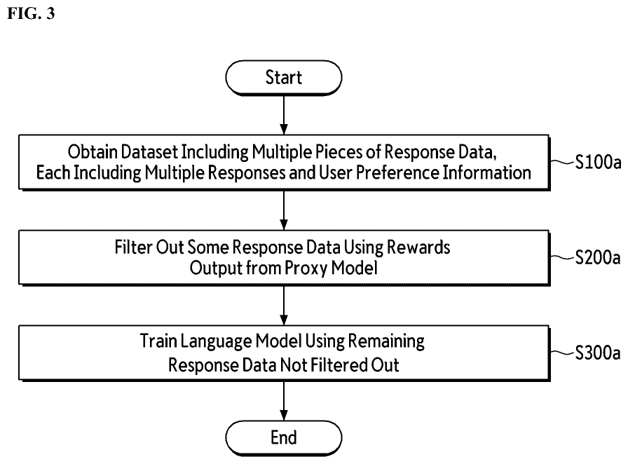

Exemplary methods for calculating reward values, reward gaps, and/or an uncertainty value for each piece of response data and filtering the dataset 10 based on these calculated values will be described later with reference to FIGS. 3 through 8.

Embodiments in which a computing device preference-trains a language model will hereinafter be described with reference to FIGS. 3 through 8. For reference, FIGS. 3 through 8 illustrate steps/operations performed by the language model training apparatus 200 of FIG. 1. Accordingly, in the following description, if the subject performing a specific step/operation is omitted, it is to be understood that the specific step/operation is performed by the language model training apparatus 200.

A method for training a language model according to an embodiment of the present disclosure will hereinafter be described with reference to FIGS. 3 through 5.

Referring to FIG. 3, in order to preference-train a language model, a dataset 10 including a plurality of pieces of response data may be obtained (S100a), and each of the plurality of pieces of response data may include multiple responses generated by the language model for a query (or context) and user preference information corresponding to each of the multiple responses.

Some of the plurality of pieces of response data included in the dataset 10 may be filtered out (S200a) using reward values output from a proxy model that receives, as input, the dataset 10 obtained in step S100a.

Thereafter, the language model may be trained (S300a) using other pieces of response data that have not been filtered out in step S200a.

In step S200a, the proxy model is an AI-based model that outputs or calculates filtering criteria values (e.g., reward values, uncertainty values, etc.) for filtering the dataset 10.

The proxy model may be a model trained through supervised learning using training data that includes at least one query, responses generated by the language model for the at least one query, user preference information for each of the generated responses, and assigned/set reward values for each of the generated responses.

Accordingly, the proxy model may receive the dataset 10 and output/calculate the reward values for each of the plurality of pieces of response data included in the dataset 10. The proxy model may output/calculate the reward values based on user preference for the responses generated by the language model, in a similar manner to a reward model used in a reinforcement learning method for training a language model, such as RLHF.

Depending on whether the proxy model is a trained model with integrated data (e.g., the dataset 10) or with only target data for which rewards are to be output/calculated, the proxy model may be referred to as a proxy reward model or a data-specific reward model. In the present disclosure, both models are collectively referred to as proxy models without distinction.

Furthermore, the proxy model may receive each response generated by the language model and output/calculate an uncertainty value that serves as a criterion for determining whether each received response is uncertain due to an unclear or incomplete query (or context).

In step 200a, before preference-training the language model using the dataset 10, the dataset 10 may be filtered based on the rewards obtained through the proxy model, and the language model may be preference-trained using a dataset that includes only the response data that has not been filtered out, thereby reducing the cost associated with preference training.

For example, according to some embodiments of the present disclosure, the time and/or central processing unit (CPU) resources required for preference training may be reduced when the language model is trained using a noise-removed dataset than when the language model is preference-trained using the unfiltered dataset 10.

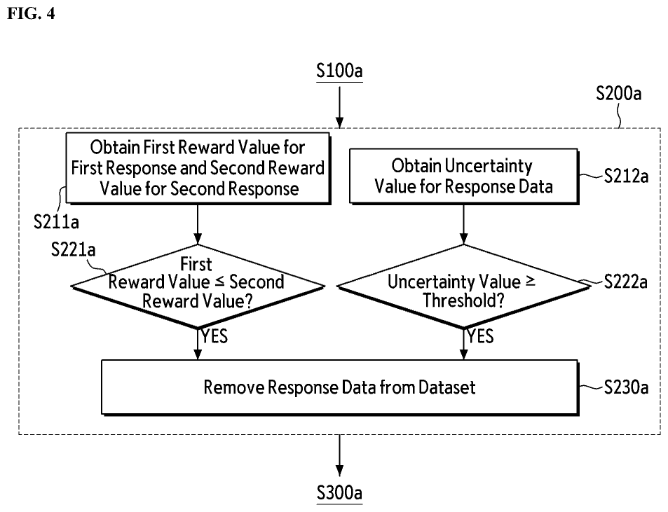

A method for filtering the dataset according to some embodiments of the present disclosure will hereinafter be described with reference to FIG. 4.

Specifically, FIG. 4 is a flowchart illustrating an exemplary method for filtering the dataset 10 using the reward values and/or uncertainty values of the plurality of pieces of response data included in the dataset 10 as filtering criteria. Steps S100a, S200a, and S300a in FIG. 4 may correspond to steps S100a, S200a, and S300a, respectively, in FIG. 3.

In step S100a, each piece of response data included in the obtained dataset 10 may be configured as a response pair consisting of a first response and a second response, and the user preference for the first response may be higher than that for the second response.

In step S200a, a first reward value for the first response and a second reward value for the second response may be obtained or output through the proxy model (S211a).

Thereafter, the first and second reward values may be compared to determine whether the first reward value is less than or equal to the second reward value (S221a), and if the first reward value is less than or equal to the second reward value, the corresponding piece of response data may be removed from the dataset 10 (S230a).

For example, the proxy model may output or calculate a greater reward value for the first response with a higher user preference than the reward value for the second response with a lower user preference. In this case, in step S221a, each piece of response data containing a response pair where the first reward value is less than or equal to the second reward value may be determined as noise and removed from the dataset 10, such that in step S230a, a dataset is configured that consists only of response data that has not been filtered out.

Pieces of response data determined to be noise in step S221a may correspond to the response data 10a and the response data 10b in FIG. 2, and in this case, the dataset configured in step S300a may consist of pieces of response data corresponding to the response data 10c in FIG. 2 and response data corresponding to the response data 10d in FIG. 2.

Additionally, in step S200a, an uncertainty value for each piece of response data included in the dataset 10 may be output from the proxy model (S212a).

Thereafter, the uncertainty value may be compared with a threshold to determine whether the uncertainty value is greater than or equal to the threshold (S222a), and if the uncertainty value is greater than or equal to the threshold, the corresponding piece of response data may be determined as noise and removed from the dataset 10 (S230a).

Here, the threshold, which is a value used as a criterion to determine whether each piece of response data is noise based on its uncertainty value and should be removed from the dataset 10, may be determined in advance.

For example, the proxy model may output or calculate a high uncertainty value for each piece of response data included in the dataset 10 that is suspected of being uncertain because the query (or context) in S100a is unclear or incomplete.

Pieces of response data determined to be noise in step S222a may correspond to the response data 10a and the response data 10c in FIG. 2, and in this case, the dataset configured in step S300a may consist of response data corresponding to the response data 10b in FIG. 2 and response data corresponding to the response data 10d in FIG. 2.

In FIG. 4, steps S211a, S221a, S212a, and S222a are illustrated as optional steps, but the present disclosure is not limited thereto. For example, the language model training apparatus 200 may filter out each piece of response data that includes a response pair where the first reward value is less than or equal to the second reward value from the dataset 10, and may further filter out each query-response pair (i.e., each piece of response data) determined to be ambiguous or suspected to be uncertain from the dataset 10, thereby filtering the dataset 10.

In step S300a of FIG. 3 and/or step S300a of FIG. 4, the language model may be trained using one of a Reinforcement Learning from Human Feedback (RLHF) or a Direct Preference Optimization (DPO) method, but the present disclosure is not limited thereto. Alternatively, Rank Responses to Align Language Models with Human Feedback without Tears (RRHF) and Sequence Likelihood Calibration with Human Feedback (SLiC-HF) may also be used to preference-train the language model.

Furthermore, in step S300a of FIG. 3 and/or step S300a of FIG. 4, training the language model using a dataset consisting only of response data that has not been filtered out may refer to fine-tuning/optimizing a pre-trained language model to generate responses to specific queries, using a noise-removed dataset.

When the reward values for the response pair (i.e., the chosen and rejected responses) included in each piece of response data of the dataset 10 are denoted as r_{c} and rᵣ, the larger the difference between r_{c} and rᵣ, the better the instruction-following ability of the language model becomes when preference-training the language model with the dataset 10. This allows the language model to generate responses more aligned with user intent.

In other words, the closer the difference between r_{c} and rᵣ approaches its maximum, the more reliable the dataset 10 may be considered. In this case, r_{c}>rᵣ or (r_{c}−rᵣ)>0. Conversely, each piece of response data where r_{c}<rᵣ or (r_{c}−rᵣ)≤0 may introduce noise in the preference training of the language model.

According to some embodiments of the present disclosure, as explained earlier with reference to FIGS. 3 and 4, each piece of response data that includes a response pair where r_{c}<rᵣ or (r_{c}−rᵣ)≤0 may be filtered out from the dataset 10, thereby forming a highly reliable training dataset. Additionally, by using a dataset consisting only of response data that has not been filtered out, the language model can be preference-trained to maximize the reward difference between the chosen and rejected responses in each piece of response data, leading to improved performance compared to using an unfiltered dataset.

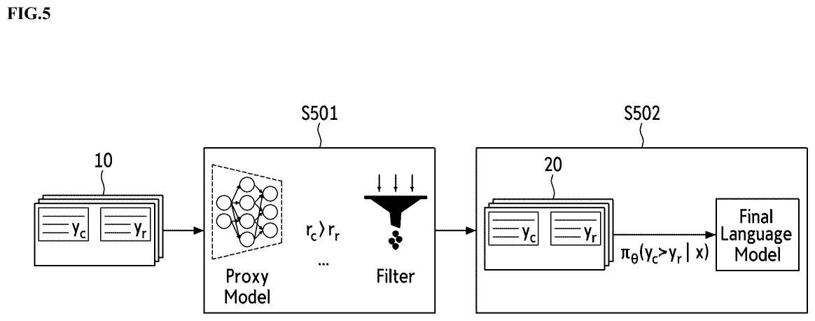

The overall operation of a language model training apparatus 200 that operates according to some embodiments of the present disclosure, described with reference to FIGS. 3 and 4, will hereinafter be explained with reference to FIG. 5.

Specifically, FIG. 5 illustrates the overall operation flow in which the language model training apparatus 200 filters the dataset 10 before preference-training the language model and preference-trains the language model using the filtered dataset.

Step S501 of FIG. 5 represents the process of filtering the dataset 10, and step S502 of FIG. 5 represents the process of preference-training the language model.

Referring to FIG. 5, before preference-training the language model, the dataset 10 may be filtered.

In step S501, reward values and/or an uncertainty value for each response pair included in the dataset 10 may be calculated using the proxy model, and the dataset 10 may be filtered based on these calculated values.

If the dataset 10 is denoted as D, the proxy model as re, a specific query as x, a chosen response for the query x with higher user preference as y_{c}, and a rejected response for the query x with lower user preference as yᵣ, then, the loss for training the proxy model in step S501 may be expressed as follows:

$$- {E}_{( x , {y}_{c} , {y}_{r} ) ∼ D} [ log ( σ ( {r}_{θ} ( {y}_{c} \vert x ) - {r}_{θ} ( {y}_{r} \vert x ) ) ) ] .$$

Additionally, for example, in step S501, each piece of response data where the chosen response y_{c} and the rejected response yᵣ are switched may be filtered out from the dataset 10, thereby forming a noise-removed dataset 20 that consists only of response pairs that satisfy (r_{c}−rᵣ)>0. Consequently, in step S502, the language model may be preference-trained using the noise-removed dataset 20 such that the chosen response y_{c} is more likely to be generated than the rejected response yᵣ, as follows: π_{θ}(y_{c} [symbol] yᵣ|x).

In another example, in step S501, each piece of response data with an uncertainty value equal to or greater than a predefined threshold (e.g., 0.6) may be filtered out from the dataset 10 as uncertain response data.

For example, when the probability that each response pair included in the dataset 10 is clearly distinguishable and the probability that each response pair included in the dataset 10 is not clearly distinguishable are denoted as P_{y}_{_{c}} [symbol] _{y}_{ᵣ} and P_{y}_{_{c}} [symbol] _{y}_{ᵣ}, respectively, an uncertainty value U(P) for each piece of response data may then be defined as follows:

$$U ( P ) = - E ( {\sum }_{i ∈ I} {P}_{i} log {P}_{i} ) ;$$

$$and$$

$$P := ( {P}_{{y}_{c} {y}_{r}} , {P}_{{y}_{c} ≺ {y}_{r}} ) , {P}_{{y}_{c} ≺ {y}_{r}} = 1 - {P}_{{y}_{c} {y}_{r}} , {P}_{{y}_{c} {y}_{r}} := σ ( {r}_{c} , {r}_{r} ) .$$

Thereafter, in step S502, the language model is trained using the noise-removed dataset 20 obtained in step S501, resulting in a final language model that has learned human feedback.

Since in step S502, the language model is trained using the noise-removed dataset that does not include data that negatively impacts training, the final language model can achieve higher performance than when preference training is performed only using the unfiltered dataset 10 that includes noise. Additionally, by reducing the size of the dataset 10 through filtering, the time and computational (e.g., memory and CPU) resources required for training can also be reduced.

When the noise-removed dataset 20 in step S501 is denoted as D_{f}, the existing language model as π_{θ}, and the model currently being trained (fine-tuned) as π_{ref}, the loss for preference-training the language model using the nose-removed dataset 20 in step S502 may be expressed as follows:

$$- {E}_{( x , {y}_{c} {y}_{r} ) ∼ {D}_{f}} [ log σ ( β log \frac{{π}_{θ} ( {y}_{c} \vert x )}{{π}_{ref} ( {y}_{c} \vert x )} - β log \frac{{π}_{θ} ( {y}_{r} \vert x )}{{π}_{ref} ( {y}_{r} \vert x )} ) ] .$$

Step S501 in FIG. 5 may correspond to step S200a in FIG. 3 and step S200a in FIG. 4, and step S502 in FIG. 5 may correspond to step S300a in FIG. 3 and step S300a in FIG. 4.

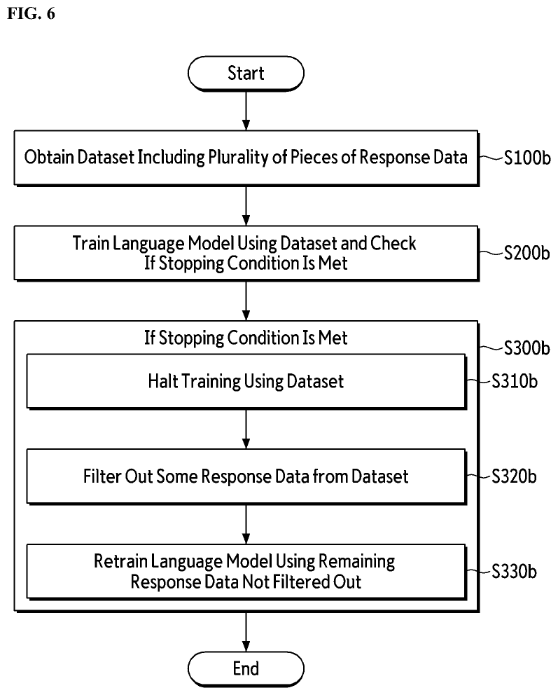

A method for training a language model according to another embodiment of the present disclosure will hereinafter be described with reference to FIGS. 6 through 8.

Referring to FIG. 6, a dataset 10 including a plurality of pieces of response data may be obtained (S100b), and each of the plurality of pieces of response data may include multiple responses generated by the language model for a query (or context) and user preference information corresponding to each of the multiple responses.

The language model may be trained using the dataset 10 to increase the likelihood of generating responses with higher user preference, and a determination may be made as to whether a stopping condition is met (S200b).

If the stopping condition is met (S300b), the training using the dataset 10 may be halted (S310b), and some of the plurality of pieces of response data may be filtered out (S320b).

Thereafter, the language model trained in step S220b may be retrained (S330b) using other pieces of response data that have not been filtered out in step S320b.

In other words, if the stopping condition is met during the preference training of the language using the dataset 10, the dataset 10 may be filtered, and training may resume using the noise-removed dataset.

In step S310b, halting the training using the dataset 10 means discontinuing training with the unfiltered dataset 10 in order to train the language model using a noise-removed dataset, but should not be interpreted as requiring a complete interruption of the training process solely for the purpose of filtering the dataset 10.

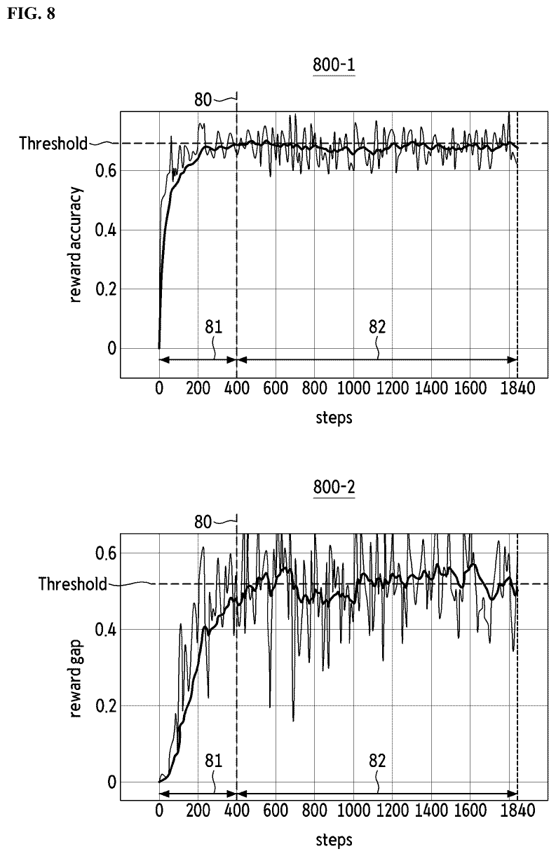

In other words, an actual break may not necessarily occur between the training using the dataset 10 in step S200b and the training using the noise-removed dataset in step S330b, and training may be continued continuously from step S200b to step S330b. This will be described later in further detail with reference to FIG. 8.

In the present embodiment, unlike in the embodiment of FIGS. 3 through 5, where the dataset 10 is filtered before preference training, the dataset 10 may be filtered during preference training, as illustrated in FIG. 6. In this case, the language model itself may be used for filtering the dataset 10. Consequently, since the dataset 10 can be filtered using the language model without a requirement of a separate model, such as the proxy model, the cost of generating or configuring a separate filtering model (i.e., the proxy model) is not incurred.

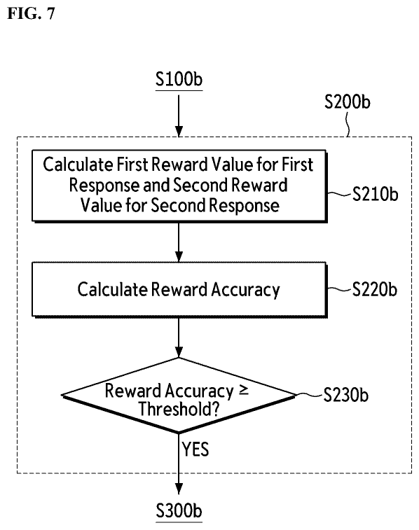

An example of a method for determining whether the stopping condition for halting the training using the dataset 10 is met in step S200b will be described later with reference to FIG. 7.

In step S320b, as in the embodiment of FIGS. 3 through 5 where the dataset 10 is filtered before preference training, filtering criteria may include reward values and/or an uncertainty value for each of the plurality of pieces of response data.

Exemplary methods for calculating reward values and/or uncertainty values as filtering criteria in step S320b and for filtering out some of the plurality of pieces of response data included in the dataset 10 based on the calculated values will hereinafter be described.

Each piece of response data included in the dataset 10 obtained in step S100b may be configured as a response pair consisting of a first response and a second response, and the user preference for the first response may be higher than that for the second response.

In this case, in step S320b, a first reward value for the first response and a second reward value for the second response may be calculated as filtering criteria.

Thereafter, the first and second reward values may be compared to determine whether the first reward value is less than or equal to the second reward value, and if the first reward value is less than or equal to the second reward value, the corresponding piece of response data may be removed from the dataset 10. Here, pieces of response data determined as noise may correspond to the response data 10a and the response data 10b in FIG. 2, and in this case, the dataset configured in step S320b may consist of response data corresponding to the response data 10c in FIG. 2 and response data corresponding to the response data 10d in FIG. 2.

Additionally, in step S320b, an uncertainty value for each piece of response data may be calculated as a filtering criterion.

Thereafter, the uncertainty value may be compared with a predefined threshold to determine whether the uncertainty value is greater than or equal to the threshold, and if the uncertainty value is greater than or equal to the threshold, the corresponding piece of response data may be determined as noise and removed from the dataset 10.

Here, the threshold, which is a value used as a criterion to determine whether each piece of response data is noise based on its uncertainty value and should be removed from the dataset 10, may be set in advance.

In step S320b, since the language model already preference-trained or currently being preference-trained, instead of a separate model, such as the proxy model, is used to filter the dataset 10, the reward values and/or uncertainty value for each response pair may be implicit values and/or uncertainty value calculated/set by the language model.

For example, if the difference between the implicit reward values for the chosen and rejected responses is negative or close to zero, the corresponding piece of response data may be determined as noise and removed from the dataset 10.

Training the language model using the dataset 10 in step S200b and/or retraining the preference-trained language model using the noise-removed dataset in step S330b may be performed using the DPO method, but the present disclosure is not limited thereto.

Additionally, training the language model using the dataset 10 in step S200b may refer to fine-tuning/optimizing a pre-trained language model to generate responses to specific queries, using the dataset 10.

Furthermore, retraining the preference-trained language model using the noise-removed dataset in step S330b may refer to continuing the fine-tuning/optimization of the language model that has been fine-tuned/optimized in step S200b, using the noise-removed dataset.

According to some embodiments of the present disclosure, preference-training the language model using a noise-removed dataset allows the language model to be trained in a manner that maximizes the difference between the rewards for the chosen and rejected responses in each piece of response data, leading to improved performance compared to when using an unfiltered dataset.

In other words, by retraining the preference-trained language model using the noise-removed dataset in step S330b, the cost associated with preference training can be reduced.

For example, according to some embodiments of the present disclosure, when a predetermined condition is met during the training of the language model, the training using the dataset 10 is halted, and the training process continues using the noise-removed dataset. Even when considering the time required for filtering the dataset 10, the time and computational resources required for backpropagation during model optimization can be reduced compared to a case where the entire training process is performed using the unfiltered dataset 10. This results in a reduction in both time and CPU resources required for preference training.

A method for determining whether the stopping condition in step S200b of FIG. 6 is met, according to some embodiments of the present disclosure, will hereinafter be described with reference to FIG. 7. Steps S100b, S200b, and S300b in FIG. 7 may correspond to steps S100b, S200b, and S300b in FIG. 6.

As described above, each of the plurality of pieces of response data included in the dataset 10 may be configured as a response pair consisting of a first response and a second response, and the user preference for the first response may be higher than that for the second response.

Referring to FIG. 7, in step S200b, the stopping condition for halting training using the dataset 10 may be set based on the reward accuracy of the language model for the dataset 10.

First, in step S200b, a first reward value for the first response and a second reward value for the second response may be calculated for each of the plurality of pieces of response data (S210b).

Thereafter, based on these calculated values, the reward accuracy of the language model for the dataset 10 may be calculated (S220b). Here, reward accuracy may refer to the average ratio of cases where the first reward value is calculated to be greater than the second reward value to cases where the first reward value is calculated to be less than the second reward value for each of the plurality of pieces of response data. For example, the reward accuracy of the language model for the dataset 10 may refer to the average probability that the reward value for the chosen response is greater than the reward value for the rejected response for each of the plurality of pieces of response data included in the dataset 10.

Thereafter, the reward accuracy calculated in step S220b may be compared with a threshold to determine whether the reward accuracy is equal to or greater than the threshold (S230b), and if the reward accuracy is equal to or greater than the threshold, the stopping condition may be determined to be met.

Here, the threshold, which is a value used as a criterion to determine whether the stopping condition is met, may be set in advance.

The stopping condition and the halting of training in step S200b will hereinafter be described in further detail with reference to FIG. 8.

FIG. 8 is a graph illustrating how reward accuracy and reward gap change during the training of a language model using a dataset 10 that includes noise.

Referring to FIG. 8, the preference training of the language model may be performed in multiple iterations. In other words, preference-training the language model may refer to fine-tuning the language model repeatedly using training data, meaning that after a predetermined number of fine-tuning iterations, the trained language model is further fine-tuned.

For example, training the language model using training data may refer to fine-tuning the language model repeatedly for a certain number of steps, using the training data.

In this case, due to the nature of preference training, implicit reward values for each of the plurality of pieces of response data included in the dataset 10 may be calculated during training.

Reference numeral 800-1 represents a graph showing changes in the reward accuracy of the language model for a training dataset, specifically, how the average reward accuracy, which is the probability that the reward value for the chosen response is greater than the reward value for the rejected response for each piece of response data included in the training dataset, changes over steps. Reference numeral 800-2 represents a graph of changes in the reward gap for the training dataset, specifically, how the average reward gap, which is the difference between the reward value for the chosen response and the reward value for the rejected response for each piece of response data included in the training dataset, changes over steps.

Referring to graphs 800-1 and 800-2, when preference training of the language model progresses for a number of steps, the reward accuracy and/or reward gap of the language model for the training dataset may converge to a predefined threshold.

According to some embodiments of the present disclosure, the language model training apparatus 200 may filter the training dataset at a starting point 80 of a section where the reward accuracy and/or reward gap for the training dataset converges to a predefined threshold.

For example, as illustrated in FIG. 8, the starting point 80 may be identified after approximately 20% to 30% of the steps in a preference training process that consists of 1,840 steps. At this point, the batch size may be adjusted, for example, to 1, and then, filtering criteria for the training dataset may be calculated and applied to filter the training dataset.

In other words, according to some embodiments of the present disclosure, the language model may be trained using the unfiltered dataset 10 during section 81, which occurs before the starting point 80 at which the reward accuracy and/or reward gap for the dataset 10 converges to a predefined threshold. After the starting point 80, during section 82, the language model may be trained using the noise-removed dataset. For ease of explanation, the training in section 81 will hereinafter be referred to as phase 1, and the training in section 82 will hereinafter be referred to as phase 2.

Here, phase 1 corresponds to the training phase using the dataset 10 in step S200b in FIG. 6, and phase 2 corresponds to the training phase using the noise-removed dataset in step S330b in FIG. 6.

Due to the nature of preference training, the reward values for each of the plurality of pieces of response data included in the dataset 10 are calculated during training. Thus, the training of the language model may be performed continuously without interruption between phase 1 and phase 2.

Accordingly, in the present disclosure, halting the training using the dataset 10 and retraining the preference-trained language model using the noise-removed dataset may mean that training proceeds for a predetermined number of steps using the unfiltered dataset 10 as training data, and then continues for the remaining steps using the noise-removed dataset as training data.

In other words, at the starting point 80 of the section where the reward accuracy and/or reward gap converges to a predefined threshold, a determination may be made as to whether the reward accuracy and/or reward gap is equal to or greater than the predefined threshold, without an interruption of training. If it is determined that the reward accuracy and/or reward gap is equal to or greater than the predefined threshold, the dataset 10 may be filtered, and in phase 2, training using the filtered dataset may proceed without interruption from the training in phase 1.

The overall operation of the language model training apparatus 200 that operates according to some embodiments of the present disclosure, described with reference to FIGS. 6 and 7 will be explained.

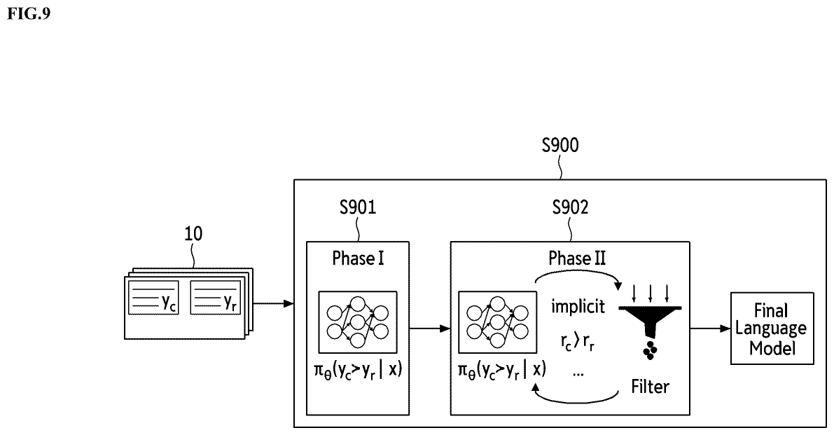

Specifically, FIG. 9 illustrates the overall operational flow in step S901, where the language model training apparatus 200 trains the language model while simultaneously filtering the dataset 10, and preference-trains the language model using the filtered dataset, as described in FIGS. 6 and 7.

Referring to FIG. 9, step S901 corresponds to phase 1, during which the language model is trained using the unfiltered dataset 10, and step S902 corresponds to phase 2, during which the dataset 10 is filtered and then used to train the language model. As a result of phase 1 and phase 2, a final language model that has learned human feedback may be generated.

When the dataset 10 is denoted as D, the proxy model as r_{θ}, a specific query as x, a chosen response for the query x with higher user preference as y_{c}, a rejected response with lower user preference as yᵣ, the existing language model as π_{θ}, and the model currently being trained (or fine-tuned) as π_{ref}, in phase 1 and/or phase 2, the language model may be preference-trained such that the chosen response y_{c} is more likely to be generated than the rejected response yᵣ, as follows: π_{θ}(y_{c} [symbol] yᵣ|x).

For example, in phase 1 (or step S901), the loss used for preference-training the language model using the dataset 10 may be expressed as follows:

$$- {E}_{( x , {y}_{c} , {y}_{r} ) ∼ {D}_{f}} [ log σ ( β log \frac{{π}_{θ} ( {y}_{c} \vert x )}{{π}_{ref} ( {y}_{c} \vert x )} - β log \frac{{π}_{θ} ( {y}_{r} \vert x )}{{π}_{ref} ( {y}_{r} \vert x )} ) ] .$$

For example, in phase 2 (or step S902), implicit reward values r_{c} and rᵣ for the chosen and rejected responses y_{c} and yᵣ, respectively, may be calculated to filter the dataset 10, as follows:

$${r}_{c} = log {π}_{θ} ( {y}_{c} \vert x ) - log {π}_{ref} ( {y}_{c} \vert x ) ;$$

$$and$$

$${r}_{r} = log {π}_{θ} ( {y}_{r} \vert x ) - log {π}_{ref} ( {y}_{r} \vert x ) .$$

For example, in step S902, each piece of response data where the chosen and rejected responses y_{c} and yᵣ are switched may be removed from the dataset 10, thereby forming a noise-removed dataset consisting only of pieces of response pairs that satisfy (r_{c}−rᵣ)>0. Consequently, in S902, the language model may be preference-trained using the noise-removed dataset such that the chosen response y_{c} is more likely to be generated than the rejected response yᵣ.

In another example, in S902, pieces of response data determined to be uncertain, having an uncertainty value equal to or greater than a predefined threshold (e.g., 0.6), may be removed from the dataset 10.

For example, when the probability that each response pair included in the dataset 10 is clearly distinguishable and the probability that each response pair included in the dataset 10 is not clearly distinguishable are denoted as P_{y}_{_{c}} [symbol] _{y}_{ᵣ} and P_{y}_{_{c}} [symbol] _{y}_{ᵣ}, respectively, an uncertainty value U(P) for each piece of response data may then be defined as follows:

$$U ( P ) = - E ( {\sum }_{i ∈ I} {P}_{i} log {P}_{i} ) ;$$

$$and$$

$$P := ( {P}_{{y}_{c} {y}_{r}} , {P}_{{y}_{c} ≺ {y}_{r}} ) , {P}_{{y}_{c} ≺ {y}_{r}} = 1 - {P}_{{y}_{c} {y}_{r}} , {P}_{{y}_{c} {y}_{r}} := σ ( {r}_{c} , {r}_{r} ) .$$

In step S902, since phase 2 is performed using the noise-removed dataset that does not include data that negatively impacts training, the final language model can achieve higher performance than when preference training is performed using only the unfiltered dataset 10 that includes noise. Additionally, by reducing the size of the dataset 10 through filtering, the time and computational (e.g., memory and CPU) resources required for training can also be reduced.

For example, when the noise-removed dataset is denoted as D_{f}, the loss used in phase 2 (or step S902) for preference-training the language model using the noise-removed dataset D_{f} may be expressed as follows:

$$- {E}_{( x , {y}_{c} , {y}_{r} ) ∼ {D}_{f}} [ log σ ( β log \frac{{π}_{θ} ( {y}_{c} \vert x )}{{π}_{ref} ( {y}_{c} \vert x )} - β log \frac{{π}_{θ} ( {y}_{r} \vert x )}{{π}_{ref} ( {y}_{r} \vert x )} ) ] .$$

Step S901 in FIG. 9 may correspond to step S200b in FIG. 6 and step S200b in FIG. 7, and step S902 in FIG. 9 may correspond to step S300b in FIG. 6 and step S300b in FIG. 7.

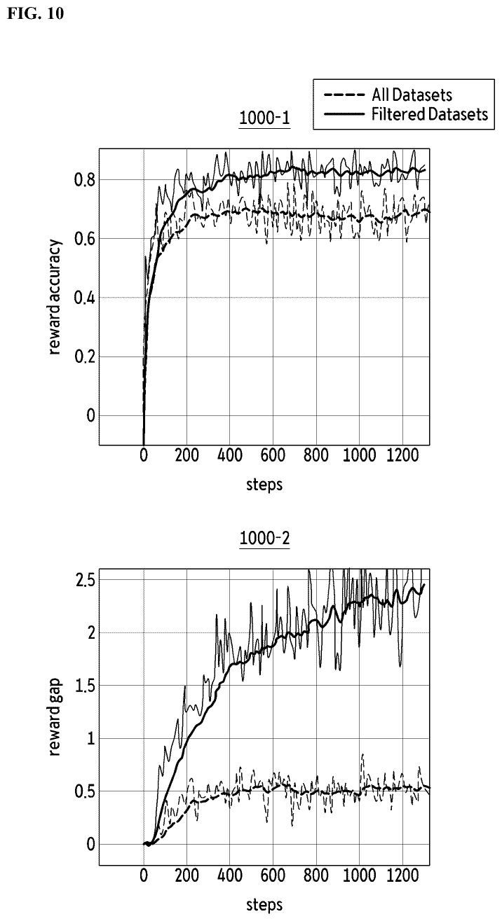

FIG. 10 is a graph illustrating how reward accuracy and reward gap change during the training of a language model using a noise-removed dataset, according to some embodiments of the present disclosure.

Referring to FIG. 10, according to some embodiments of the present disclosure, described with reference to FIGS. 6 through 9, preference training with the noise-removed dataset can significantly improve the reward accuracy of the language model compared to training with the unfiltered dataset 10 that includes noise. Additionally, the reward gap of the training dataset for the language model can also be significantly improved.

Furthermore, although not illustrated in FIG. 10, the performance of a language model trained using a noise-removed training dataset according to some embodiments of the present disclosure, described with reference to FIGS. 3 through 5 and FIGS. 6 through 9, can be improved compared to a language model trained using only the original unfiltered training dataset that includes noise, as verified through qualitative evaluation using Generative Pre-trained Transformer (GPT)-4.

Additionally, according to some embodiments of the present disclosure, described with reference to FIGS. 3 through 5 and FIGS. 6 through 9, the performance of a training model for preference training can be enhanced without changing the objective of a preference-training method such as RLHF or DPO.

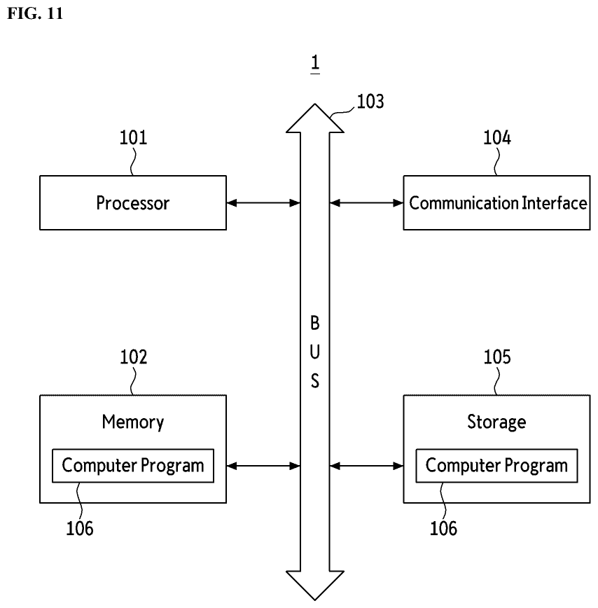

FIG. 11 is an illustrative hardware configuration diagram illustrating the computing device 160.

Referring to FIG. 11, the computing device 1 may include at least one processor 101, a system bus 103, a communication interface 104, a memory 102, which loads a computer program 106 executed by the processor 101, and a storage 105, which stores the computer program 106. Even though FIG. 11 depicts only components related to the embodiments of the present disclosure, it is obvious to one of ordinary skill in the art to which the present disclosure pertains that the computing device 1 may further include other generic components, in addition to the components depicted in FIG. 11. Moreover, in some embodiments, the computing device 1 may be configured with some of the components depicted in FIG. 11 omitted. The components of the computing device 1 will hereinafter be described.

The processor 101 may control the overall operation of each of the components of the computing device 1. The processor 101 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 101 may perform computations for at least one application or program to execute operations/methods according to some embodiments of the present disclosure. The computing device 1 may be equipped with one or more processors.

The memory 102 may store various data, commands, and/or information. The memory 102 may load the computer program 166 from the storage 105 to execute the operations/methods according to some embodiments of the present disclosure. The memory 102 may be implemented as a volatile memory such as a random-access memory (RAM), but the present disclosure is not limited thereto.

The bus 103 may provide communication functionality between the components of the computing device 1. The bus 103 may be implemented in various forms such as an address bus, a data bus, and a control bus.

The communication interface 104 may support wired or wireless Internet communication of the computing device 1. Additionally, the communication interface 104 may also support various other communication methods. To this end, the communication interface 104 may be configured to include a communication module well-known in the technical field of the present disclosure.

The storage 105 may non-transitorily store at least one computer program 106. The storage 105 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 106, when loaded into the memory 102, may include one or more instructions that enable the processor 101 to perform the operations/methods according to some embodiments of the present disclosure. That is, by executing the loaded one or more instructions, the processor 101 may perform the operations/methods according to some embodiments of the present disclosure.

For example, the computer program 106 may include instructions for the operations of: obtaining a dataset that includes a plurality of pieces of response data, wherein each of the plurality of pieces of response data includes multiple responses generated by a language model for a query and user preference information corresponding to each of the multiple responses; filtering out some of the plurality of pieces of response data, using reward values for each of the plurality of pieces of response data, output from a proxy model that receives the dataset as input; and training the language model using only other pieces of response data that have not been filtered out.

In another example, the computer program 106 may include instructions for the operations of: obtaining a dataset that includes a plurality of pieces of response data, wherein each of the plurality of pieces of response data includes multiple responses generated by a language model for a query and user preference information corresponding to each of the multiple responses; training the language model using the dataset to increase the likelihood of generating responses with higher user preference, and determining whether a stopping condition is met; halting the training the language model using the dataset when the stopping condition is met; filtering out some of the plurality of pieces of response data included in the dataset, and retraining the trained language model using only other pieces of response data that have not been filtered out.

According to some embodiments of the present disclosure, by removing noise from a dataset that includes a plurality of pieces of response data for a specific query that reflect user preferences, a highly reliable dataset for preference-training the language model can be built.

Furthermore, according to some embodiments of the present disclosure, training and retraining the language model using the noise-removed dataset can improve the reliability of the language model. Specifically, the instruction-following ability of the language model to generate responses aligned with user intent can be improved.

Various embodiments of the present disclosure and their effects have been described so far with reference to FIGS. 1 through 11. The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for preference-training a language model, performed by a computing device, the method comprising:
obtaining a dataset including a plurality of pieces of response data, wherein each of the plurality of pieces of response data includes multiple responses generated by the language model for a query and user preference information corresponding to each of the multiple responses;
filtering out some of the plurality of pieces of response data included in the dataset using reward values for each of the plurality of pieces of response data, output from a proxy model that receives the dataset as input; and
training the language model using other pieces of response data that have not been filtered out.

2. The method of claim 1, wherein the proxy model is trained through supervised learning using training data that includes the query, a response generated by the language model for the query, the user preference information for the response, and set reward value for the response.

3. The method of claim 1, wherein
each of the plurality of pieces of response data is configured as a response pair including a first response and a second response,
user preference for the first response is higher than user preference for the second response,
the reward values for each of the plurality of pieces of response data include a first reward value for the first response and a second reward value for the second response, and
the filtering out some of the plurality of pieces of response data comprises: comparing the first and second reward values; and
removing, from the dataset, each piece of response data for which the first reward value is less than or equal to the second reward value.

4. The method of claim 1, wherein the filtering out some of the plurality of pieces of response data comprises:
obtaining an uncertainty value for each of the plurality of pieces of response data included in the dataset, output from the proxy model;
comparing the uncertainty value with a predefined threshold; and
removing, from the dataset, each piece of response data for which the uncertainty value is equal to or greater than the predefined threshold.

5. The method of claim 1, wherein the training the language model is performed using one of a Reinforcement Learning from Human Feedback (RLHF) method or a Direct Preference Optimization (DPO) method.

6. A method for preference-training a language model, performed by a computing device, the method comprising:
obtaining a dataset including a plurality of pieces of response data, wherein each of the plurality of pieces of response data includes multiple responses generated by the language model for a query and user preference information corresponding to each of the multiple responses;
training the language model using the dataset to increase a likelihood of generating responses with higher user preference, and determining whether a stopping condition is met;
when the stopping condition is met, halting the training the language model using the dataset;
filtering out some of the plurality of pieces of response data included in the dataset; and
retraining the trained language model using only other pieces of response data that have not been filtered out.

7. The method of claim 6, wherein
each of the plurality of pieces of response data is configured as a response pair consisting of a first response and a second response,
user preference for the first response is higher than that for the second response, and the determining whether the stopping condition is met comprises:
calculating a first reward value for the first response and a second reward value for the second response for each of the plurality of pieces of response data;
calculating a reward accuracy of the language model;
comparing the reward accuracy with a predefined threshold; and
determining that the stopping condition is met when the reward accuracy is equal to or greater than the predefined threshold, and
the reward accuracy is an average ratio of cases where the first reward value is greater than the second reward value to cases where the first reward value is less than the second reward value for each of the plurality of pieces of response data.

8. The method of claim 6, wherein
each of the plurality of pieces of response data is configured as a response pair consisting of a first response and a second response,
user preference for the first response is higher than that for the second response, and
the filtering out some of the plurality of pieces of response data comprises:
calculating a first reward value for the first response and a second reward value for the second response for each of the plurality of pieces of response data;
comparing the first reward value and the second reward value; and
removing, from the dataset, each piece of response data for which the first reward value is less than or equal to the second reward value.

9. The method of claim 6, wherein the filtering out some of the plurality of pieces of response data comprises:
calculating an uncertainty value for each of the plurality of pieces of response data;
comparing the uncertainty value with a predefined threshold; and
removing, from the dataset, each piece of response data for which the uncertainty value is equal to or greater than the predefined threshold.

10. The method of claim 6, wherein the training the language model and the retraining the language model are performed using a Direct Preference Optimization (DPO) method.

11. An apparatus for preference-training a language model, the apparatus comprising:
at least one processor; and
at least one memory storing instructions that, when executed by the at least one processor, cause the at least one processor to perform operations of:
obtaining a dataset including a plurality of pieces of response data, wherein each of the plurality of pieces of response data includes multiple responses generated by the language model for a query and user preference information corresponding to each of the multiple responses;
filtering out some of the plurality of pieces of response data included in the dataset using reward values for each of the plurality of pieces of response data, output from a proxy model that receives the dataset as input; and
training the language model using other pieces of response data that have not been filtered out.

12. The apparatus of claim 11, wherein the proxy model is trained through supervised learning using training data that includes the query, a response generated by the language model for the query, the user preference information for the response, and set reward value for the response.

13. The apparatus of claim 11, wherein
each of the plurality of pieces of response data is configured as a response pair including a first response and a second response,
user preference for the first response is higher than user preference for the second response,
the reward values for each of the plurality of pieces of response data include a first reward value for the first response and a second reward value for the second response, and
the operation of filtering out some of the plurality of pieces of response data comprises:
comparing the first and second reward values; and
removing, from the dataset, each piece of response data for which the first reward value is less than or equal to the second reward value.

14. The apparatus of claim 11, wherein the operation of filtering out some of the plurality of pieces of response data comprises:
obtaining an uncertainty value for each of the plurality of pieces of response data included in the dataset, output from the proxy model;
comparing the uncertainty value with a predefined threshold; and
removing, from the dataset, each piece of response data for which the uncertainty value is equal to or greater than the predefined threshold.

15. An apparatus for preference-training a language model, the apparatus comprising:
at least one processor; and
at least one memory storing instructions that, when executed by the at least one processor, cause the at least one processor to perform operations of:
obtaining a dataset including a plurality of pieces of response data, wherein each of the plurality of pieces of response data includes multiple responses generated by the language model for a query and user preference information corresponding to each of the multiple responses;
training the language model using the dataset to increase a likelihood of generating responses with higher user preference, and determining whether a stopping condition is met;
when the stopping condition is met, halting the training the language model using the dataset;
filtering out some of the plurality of pieces of response data included in the dataset; and
retraining the trained language model using only other pieces of response data that have not been filtered out.

16. The apparatus of claim 15, wherein
each of the plurality of pieces of response data is configured as a response pair consisting of a first response and a second response,
user preference for the first response is higher than that for the second response,
the operation of determining whether the stopping condition is met comprises:
calculating a first reward value for the first response and a second reward value for the second response for each of the plurality of pieces of response data;
calculating a reward accuracy of the language model; comparing the reward accuracy with a predefined threshold; and
determining that the stopping condition is met when the reward accuracy is equal to or greater than the predefined threshold, and
the reward accuracy is an average ratio of cases where the first reward value is greater than the second reward value to cases where the first reward value is less than the second reward value for each of the plurality of pieces of response data.

17. The apparatus of claim 15, wherein
each of the plurality of pieces of response data is configured as a response pair consisting of a first response and a second response,
user preference for the first response is higher than that for the second response, and
the operation of filtering out some of the plurality of pieces of response data comprises:
calculating a first reward value for the first response and a second reward value for the second response for each of the plurality of pieces of response data;
comparing the first reward value and the second reward value; and
removing, from the dataset, each piece of response data for which the first reward value is less than or equal to the second reward value.

18. The apparatus of claim 15, wherein the operation of filtering out some of the plurality of pieces of response data comprises:
calculating an uncertainty value for each of the plurality of pieces of response data;
comparing the uncertainty value with a predefined threshold; and
removing, from the dataset, each piece of response data for which the uncertainty value is equal to or greater than the predefined threshold.
